(19) United States
(12) Patent Application Publication
(10) Pub. No.: US 2025/0113815 A1
(43) Pub. Date: Apr. 10, 2025

(54) USE OF INSECT PREVENTION AND USE OF PREVENTION OF FLYING INSECT FROM STAYING

(71) Applicant: NATIONAL TAIWAN UNIVERSITY, TAIPEI (TW)

(72) Inventors: En-Cheng YANG, TAIPEI (TW); Hsiang-Wen HSIEH, TAIPEI (TW)

(21) Appl. No.: 18/640,558

(22) Filed: Apr. 19, 2024

(30) Foreign Application Priority Data
Oct. 9, 2023 (TW) 112140068
Mar. 20, 2024 (TW) 113110393

(51) Int. Cl. A01M 29/06

(52) U.S. Cl. CPC A01M 29/06; A01M 2200/012

(57) ABSTRACT

Use of insect prevention is provided in some embodiments of the present disclosure, including: providing an insect prevention item, in which a plurality of repeating patterns and a plurality of spacer patterns are represented on a surface of the insect prevention item, each of the plurality of repeating patterns is spaced apart by each of the plurality of spacer pattern, and a viewing angle of one of the plurality of repeating patterns and a spacer pattern neighboring to one of plurality of the repeating patterns represents on a plurality of ommatidias of the flying insect is less than twice of an inter-ommatidial angle of each of the plurality of ommatidias of the flying insect; and disposing the insect prevention item on an outer site of a target item.

### CROSS-REFERENCE TO RELATED APPLICATION

This application claims priority to Taiwan Application Serial Number 112140068, filed Oct. 19, 2023, and Taiwan Application Serial Number 113110393, filed Mar. 20, 2024 which is herein incorporated by reference.

### BACKGROUND

### Field of Invention

Some embodiments of the present disclosure relate to use of repeating patterns or periodic patterns for insect prevention, or use of repeating patterns or periodic patterns for prevention of a flying insect from staying.

### Description of Related Art

Since flying insects have the ability to fly and have a wide range of motion, they are easy to get close to the foraging targets (such as creatures, agricultural products or exposed cooked food) to bite and feed, causing discomfort to the foraging targets when bitten, and even causing the spread of infectious diseases.

Current insect prevention methods are still based on spraying insecticides or insect prevention spray. However, spraying insecticides or insect prevention spray is not only harmful to creatures, but may also remain in the environment, causing environmental pollution. In addition, insecticides or insect prevention spray has limited sustainability and need to be continuously replenished. For example, if it rains after spraying insecticides, the insecticides will be diluted and lost, and needs to be sprayed again to maintain the insect prevention effect.

Therefore, how to provide an environmentally and biologically friendly, long-lasting and simple insect prevention method is a problem to be solved.

### SUMMARY

Use of insect prevention is provided in some embodiments of the present disclosure, including: providing an insect prevention item, in which a plurality of repeating patterns and a plurality of spacer patterns are represented on a surface of the insect prevention item, each of the plurality of repeating patterns is spaced apart by each of the plurality of spacer patterns, and a viewing angle of one of the plurality of repeating patterns and one of the plurality of spacer patterns neighboring to the one of plurality of the repeating patterns represents on a plurality of ommatidias of the flying insect is less than twice of an inter-ommatidial angle of the flying insect; and disposing the insect prevention item on an outer site of a target item.

In some embodiments, the flying insect includes bee, mosquito, moth, butterfly, fly, dragonfly or a combination thereof.

In some embodiments, in X-Z cross-section, the inter-ommatidial angle is an angle between a first central axis of a first ommatidia and a second central axis of a second ommatidia adjacent to the first ommatidia while the first central axis and the second central axis extend toward an intersection point, and the first central axis and the second central axis intersect with the insect prevention item respectively while extending in a direction of the insect prevention item.

In some embodiments, each of the plurality of repeating patterns comprises an upper edge of a repeating pattern, and each of the plurality of spacer patterns comprises an lower edge of a spacer pattern, the upper edge of the repeating pattern and the lower edge of the spacer pattern are opposite and isolated from each other, wherein the viewing angle is an angle between the upper edge of the repeating pattern and the lower edge of the spacer pattern while the upper edge of the repeating pattern and the lower edge of the spacer pattern extend toward the intersection point.

In some embodiments, when the flying insect is within 60 cm of the insect prevention item, the viewing angle of the one of the plurality of repeating patterns and the one of the plurality of spacer patterns neighboring to the one of plurality of the repeating patterns represents on the plurality of ommatidias of the flying insect is less than twice of the inter-ommatidial angle of each of the plurality of ommatidias of the flying insect.

In some embodiments, the insect prevention item includes a shed, a tent, a clothing, a bag, a fruit bagging or a combination thereof.

In some embodiments, each of the plurality of repeating patterns includes a striped shape, a symmetrical polygon, a circle, a wavy shape, an irregular shape or a combination thereof.

In some embodiments, each of the plurality of spacer patterns includes a striped shape, a symmetrical polygon, a circle, a wavy shape, an irregular shape or a combination thereof.

In some embodiments, the plurality of repeating patterns are a first repeating pattern, a second repeating pattern and a third repeating pattern in sequence, in which the first repeating pattern, the second repeating pattern and the third repeating pattern have the same shape, size and color, in which the plurality of spacer patterns are a first spacer pattern and a second spacer pattern, the first repeating pattern is spaced apart from the second repeating pattern by the first spacer pattern, and the second repeating pattern is spaced apart from the third repeating pattern by the second spacer pattern, and the first spacer pattern and the second spacer pattern have different shapes, figures, sizes, or colors.

In some embodiments, disposing the insect prevention item on the outer site of the target item includes disposing the insect prevention item between the target item and the flying insect.

Use of prevention of a flying insect from staying is provided in some embodiments of the present disclosure, including: providing an insect prevention item, in which a plurality of periodic patterns side by side are represented on a surface of the insect prevention item, and a viewing angle of one of the plurality of periodic patterns represents on a plurality of ommatidias of the flying insect is less than twice of an inter-ommatidial angle of each of the plurality of ommatidias of the flying insect; and disposing the insect prevention item on an outer site of a target item.

In some embodiments, the inter-ommatidial angle is an angle between a first central axis of a first ommatidia and a second central axis of a second ommatidia adjacent to the first ommatidia while the first central axis and the second central axis extend toward an intersection point, and the first central axis and the second central axis intersect with the insect prevention item respectively while extending in a direction of the insect prevention item.

In some embodiments, in X-Z cross-section, each of the plurality of periodic patterns comprises a first unit cut line and a second unit cut line opposite to the first unit cut line, wherein the viewing angle is an angle between the first unit cut line and the second unit cut line while the first unit cut line and the second unit cut line extend toward the intersection point.

In some embodiments, each of the plurality of periodic patterns includes a striped shape, a symmetrical polygon, a circle, a wavy shape, an irregular shape or a combination thereof.

In some embodiments, each of the plurality of periodic patterns includes a repeating pattern and a spacer pattern, in which the repeating pattern and the spacer pattern have different shapes, figures, sizes, or colors.

In some embodiments, the repeating patterns of the plurality of periodic patterns neighboring to each other are spaced apart by the spacer pattern.

In some embodiments, when the flying insect is within 60 cm of the insect prevention item, the viewing angle of the one of the plurality of periodic patterns represents on the plurality of ommatidias of the flying insect is less than twice of the inter-ommatidial angle of each of the plurality of ommatidias of the flying insect.

It is to be understood that both the foregoing general description and the following detailed description are examples and are intended to provide further explanation of the present disclosure as claimed.

### BRIEF DESCRIPTION OF THE DRAWINGS

In order to allow the above-mentioned and other purposes, features, advantages and embodiments of the present disclosure to be more clearly understood, accompanying drawing is described as follows:

FIG. 1 illustrates a schematic diagram while a flying insect looks toward an insect prevention item located at an outer site of a target item.

FIG. 2A, FIG. 2B, FIG. 2C, FIG. 2D, FIG. 2E and FIG. 2F respectively illustrate pattern aspects on a pattern layer of the insect prevention item.

FIG. 3A, FIG. 3B, FIG. 3C, FIG. 3D and FIG. 3E respectively illustrate item types that the insect prevention item can be applied to.

### DETAILED DESCRIPTION

It is to be understood that different implementations or embodiments provided in the following may implement different features of the subject matter of the present disclosure. The embodiments of specific components and arrangements are used to simplify the disclosure and not to limit the disclosure. Of course, these are only examples and are not intended to be limiting. For example, the description below that the first feature is formed on the second feature includes the two being in direct contact, or there are other additional features between the two that are not in direct contact. Furthermore, the present disclosure may repeat reference numerals and/or symbols in the various embodiments. Such repetition is for simplicity and clarity and does not represent a relationship between the various embodiments and/or configurations discussed.

Terms used in this specification generally have their ordinary meanings in the art and in the context in which they are used. The embodiments used in this specification, including examples of any terms discussed herein, are illustrative only and do not limit the scope and meaning of the disclosure or any exemplified terms. Likewise, the present disclosure is not limited to some of the implementations provided in this specification.

It will be understood that, although the terms “first,” “second,” etc., may be used herein to describe various elements, these elements should not be limited by these terms. These terms are used to distinguish one element from another. For example, a first element could be termed a second element, and similarly, a second element could be termed a first element, without departing from the scope of the embodiments.

As used herein, the phrase “and/or” includes any and all combinations of one or more of the associated listed items.

As used herein, the terms “comprise,” “include,” “has,” etc. are to be understood as open-ended, that is, to mean including but not limited to.

As used herein, the term “repeating pattern” means a specific pattern that appears regularly multiple times.

Some embodiments of the present disclosure provide use of insect prevention, including: providing an insect prevention item, in which a plurality of repeating patterns and a plurality of spacer patterns are represented on a surface of the insect prevention item, each of the plurality of repeating patterns is spaced apart by each of the plurality of spacer patterns, and a viewing angle of one of the plurality of repeating patterns and one of the plurality of spacer patterns neighboring to the one of plurality of the repeating patterns represents on a plurality of ommatidias of the flying insect is less than twice of an inter-ommatidial angle of each of the plurality of ommatidias of the flying insect; and disposing the insect prevention item on an outer site of a target item.

It is worth emphasizing that according to the design that the viewing angle of each repeating pattern and the spacer patterns neighboring to each repeating pattern represents on a plurality of ommatidias of the flying insect is less than twice of the inter-ommatidial angle of each of the plurality of ommatidias of the flying insect, the vision of the flying insect can be interfered, making it impossible for the flying insect to accurately confirm the position of the repeating pattern to stop at the insect prevention item located at the outer site of the target item, thereby preventing the flying insect from approaching the target item (the item to be protected).

Since different flying insects have different preferences for different color patterns. Theoretically, the insect prevention item can be designed based on the color preference of the respective flying insect. However, since various flying insects have different preferences for color, design based on color preferences has the limitation of preventing multiple flying insects from approaching at the same time (for example, while bees are prevented from approaching, mosquitoes are unable to be avoided).

The present disclosure controls the viewing angle of the ommatidias of the flying insect by controlling the pattern of the insect prevention item so that the viewing angle is less than twice of the inter-ommatidial angle. After confirming the inter-ommatidial angle of the flying insects to be prevented, the patterns applied to a variety of flying insects can be designed accordingly, thereby achieving insect prevention effects on a variety of flying insects at the same time without spraying chemicals, and the patterns are environmentally friendly and burden-free.

In addition, the insect prevention item is designed based on the principle of visual interference. The effect will not be reduced by environmental changes (such as rain), and the effect is continuous after being set. It does not need to be supplemented on time and can be stopped at any time according to changes in demand. Therefore, it is not only durable, but also extremely convenient to use.

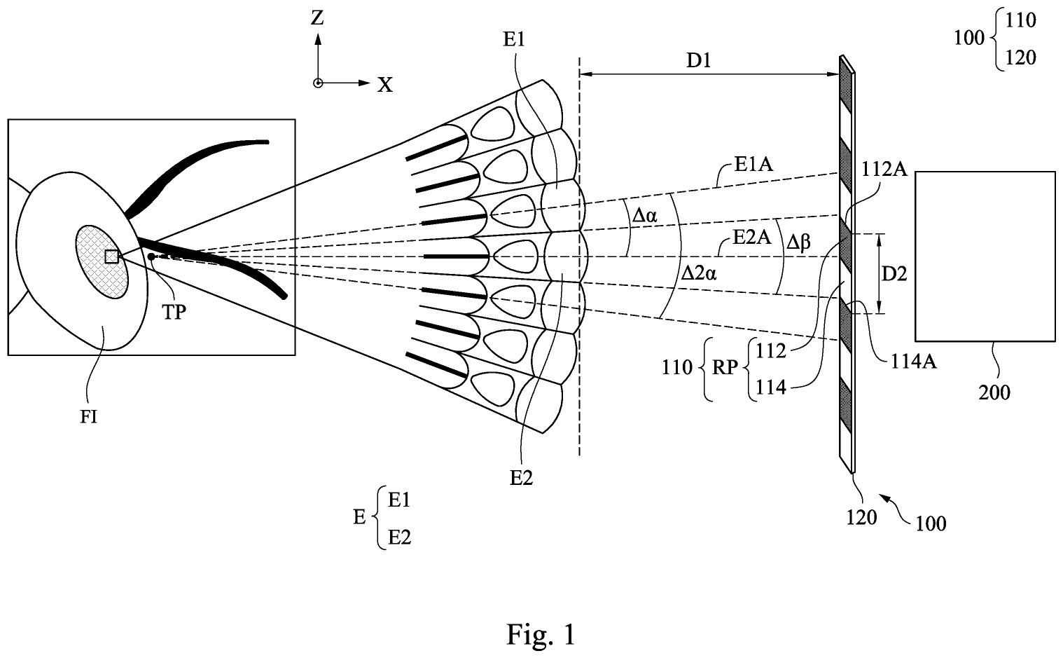

For ease of reference, please referring to FIG. 1, illustrating a schematic diagram while a flying insect looks toward an insect prevention item 100 located at an outer site of a target item 200, in which for easily illustrating the relationship between inter-ommatidial angle Δα, twice of the inter-ommatidial angle Δ2α and viewing angle Δβ, the angles are presented in X-Z cross section (Y-axis fixed).

An inter-ommatidial angle Δα of the flying insect FI is an angle between a first central axis E1A of a first ommatidia E1 and a second central axis E2A of a second ommatidia E2 adjacent to the first ommatidia E1 while the first central axis E1A and the second central axis E2A extend toward an intersection point TP. Therefore, the extend first central axis E1A and the extended second central axis E2A meet at an intersection point. The first central axis E1A and the second central axis E2A intersect with the insect prevention item 100 respectively while extending in a direction of the insect prevention item 100 (for example, intersecting with a pattern layer 110 of the insect prevention item 100). In some embodiments, in X-Z cross section, the first central axis E1A and the second central axis E2A respectively cut the first ommatidia E1 and the second ommatidia E2 in half and divide the first ommatidia E1 and the second ommatidia E2 equally.

The insect prevention item 100 includes the pattern layer 110 and a base layer 120, and the pattern layer 110 covers the base layer 120. The pattern layer 110 includes repeating patterns 112 (such as black square in the figures) and spacer patterns 114 (such as white square in the figures). That is, a surface of the insect prevention item 100 represents a plurality of repeating patterns 112, and the neighboring repeating patterns 112 are spaced apart from each other by the spacer patterns 114. The repeating patterns 112 and the spacer patterns 114 are different. That is, shape, figures, size or color is different.

The repeating patterns 112 include an upper edge of a repeating pattern 112A, an lower edge of a spacer pattern 114A, the upper edge of the repeating pattern 112A and the lower edge of the spacer pattern 114A are opposite and isolated from each other, and a distance D2 of the upper edge of the repeating pattern 112A and the lower edge of the spacer pattern 114A is a longest vertical distance between the repeating pattern 112 and the spacer pattern 114A. That is, an angle between the upper edge of the repeating pattern 112A and the lower edge of the spacer pattern 114A while the upper edge of the repeating pattern 112A and the lower edge of the spacer pattern 114A extend toward the intersection point is the viewing angle Δβ that the repeating patterns 112 and the spacer patterns 114 represent on the ommatidias E of the flying insect FI.

When the viewing angle Δβ of the repeating patterns 112 and the spacer patterns 114 represents on the ommatidias E of the flying insect FI is less than twice of the inter-ommatidial angle Δ2α, the flying insect FI will be unable to accurately determine the position of the repeating patterns 112 due to visual interference, and avoiding staying on the pattern layer 110, so that the flying insect FI is prevented from approaching the target item 200. That is, based on the design of pattern combination of the pattern layer 110 of the insect prevention item 100, the flying insect FI is prevented from approaching the target item 200.

It can be understood that since the farther the flying insect FI is away from the insect prevention item 100, the smaller the viewing angle Δβ is. Therefore, the larger the distance D1 is, the smaller the viewing angle Δβ is, and the higher the possibility of visual interference happens to the flying insect FI. In some embodiments, when the flying insect FI is within 60 cm of the insect prevention item 100, it will be identified whether the flying insect FI can land on the insect prevention item 100. When the viewing angle Δβ of the repeating patterns 112 and the spacer patterns 114 represents on the flying insect FI is less than twice of the inter-ommatidial angle Δ2α, causing visual interference of the flying insect FI, so that the flying insect FI will not approach on the insect prevention item 100 to land. Therefore, the flying insect FI will not choose to approach the target item 200. For example, the distance D1 is from 30 cm to 60 cm, that is, 30 cm, 40 cm, 50 cm, 60 cm, or any value in any of the aforementioned intervals.

In some embodiments, the flying insect FI includes bee, mosquito, moth, butterfly, fly, dragonfly or a combination thereof.

It can be understood that since different flying insects FI have different inter-ommatidial angles Δα, the scope of the viewing angle Δβ can be controlled by designing appropriate distance D2 according to the inter-ommatidial angles Δα of the flying insect FI to be prevented from approaching to achieve the purpose of avoiding the approach of specific flying insects FI. For example, when the flying insect FI is bee, since twice of the inter-ommatidial angle Δ2α is 5.6°, the distance D2 is designed to be less than 1 cm (such as from 0.1 cm to 1 cm, that is, 0.1 cm, 0.2 cm, 0.3 cm, 0.4 cm, 0.5 cm, 0.6 cm, 0.7 cm, 0.8 cm, 0.9 cm, 1 cm, or any value in any of the aforementioned intervals) to prevent the bee from approaching while the distance between the flying insect FI and the insect prevention item 100 is 30 cm. The shorter the distance D2 is, the stronger the confusion effect on the ommatidias E of the flying insect FI is. If the distance D2 is too large, the visual interference effect on the flying insect FI will be poor. If the distance D2 is too small, the manufacturing process will be more difficult.

In some embodiments, when pattern, color and width of each spacer pattern 114 is the same, the repeating patterns 112 and the spacer patterns 114 neighboring to each other can form a set of periodic patterns RP, and the pattern layer 110 of FIG. 1 represents the periodic patterns RP adjacent to each other and side by side, and the repeating patterns 112 of the neighboring periodic patterns RP are spaced apart by the spacer patterns 114. Each periodic pattern RP includes a first unit cut line (corresponding to the upper edge of the repeating pattern 112A) and a second unit cut line opposite to the first unit cut line (corresponding to the lower edge of the spacer pattern 114A). The first unit cut line (the upper edge of the repeating pattern 112A) and the second unit cut line (the lower edge of the spacer pattern 114A) are opposite and isolated from each other, and the distance D2 of the first unit cut line (the upper edge of a repeating pattern 112A) and the second unit cut line (the lower edge of a spacer pattern 114A) is the longest vertical distance between the borders of the periodic pattern RP. The angle of the first unit cut line (the upper edge of the repeating pattern 112A) and the second unit cut line (the lower edge of the spacer pattern 114A) while the first unit cut line and the second unit cut line extend toward the intersection point TP is the viewing angle Δβ that the single periodic pattern RP represents on the ommatidias E of the flying insect FI.

As stated above, since the viewing angle Δβ of the single periodic pattern RP represents on the ommatidias E of the flying insect FI is less than twice of the inter-ommatidial angle Δ2α, the flying insect FI will be unable to accurately determine the position of the periodic pattern RP due to visual interference, and avoiding staying on the pattern layer 110, so that the flying insect FI is prevented from approaching the target item 200. Therefore, the periodic patterns RP side by side can be applied to the use of prevention of the flying insect FI from staying (or insect prevention).

It can be understood that despite the same aspect of the spacer patterns 114 is represented on FIG. 1, allowing the repeating patterns 112 and the spacer patterns 114 to form the periodic pattern RP, and the periodic patterns RP are side by side, the embodiments are not limited to thereto. In some other embodiments, shapes, figures, sizes, or colors of the spacer patterns 114 are different. Basically, as long as the combination of the repeating patterns 112 and the spacer patterns 114 meets the requirement that the viewing angle Δβ is less than twice of the inter-ommatidial angle Δ2α, the approach of the flying insect FI can be avoided and the efficiency of insect prevention can be achieved.

In some embodiments, the repeating patterns 112 of the pattern layer 110 include a striped shape, a symmetrical polygon (such as triangle, rectangle, pentagon, or hexagon), circle, wavy shape, irregular shape or a combination thereof. The repeating patterns 112 are the same. In some embodiments, the spacer patterns 114 include striped shape, symmetrical polygon, circle, wavy shape, irregular shape or a combination thereof. The spacer patterns 114 can be the same or different.

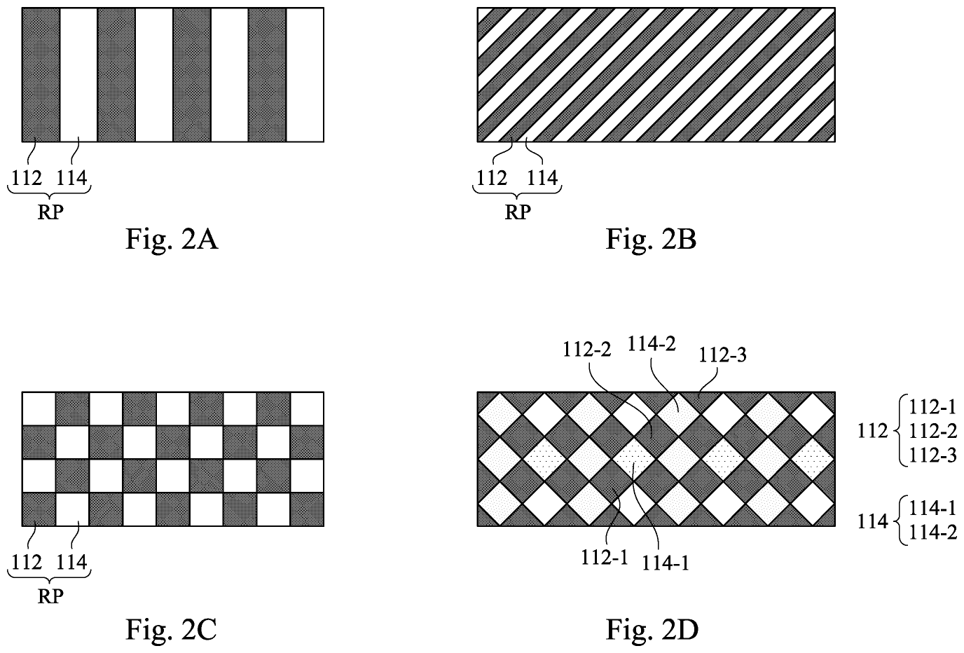

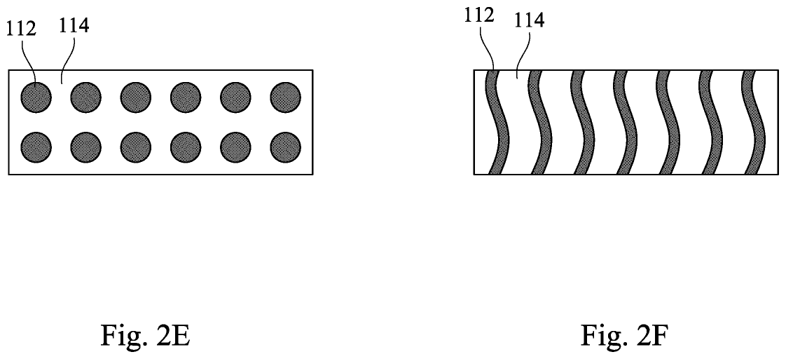

For example, please refer to FIG. 2A to FIG. 2F.

FIG. 2A represents that the repeating patterns 112 and spacer patterns 114 are respectively black straight stripes and white straight stripes, neighboring to each other and arranged regularly, making the black straight stripes be spaced apart by the white straight stripes. Therefore, the repeating patterns 112 and the spacer patterns 114 form the periodic patterns RP with alternating black and white straight stripes together.

In some embodiments, compared with FIG. 2A, the repeating patterns 112 and the spacer patterns 114 can be rotated by a specific angle and the pattern size can be changed, for example, please see FIG. 2B.

FIG. 2B represents that the repeating patterns 112 and spacer patterns 114 are respectively black diagonal stripes and white diagonal stripes, neighboring to each other and arranged regularly. Therefore, the repeating patterns 112 and the spacer patterns 114 form the periodic patterns RP with alternating black and white diagonal stripes together.

In some embodiments, compared with FIG. 2A, the shapes of the repeating patterns 112 and the spacer patterns 114 can be changed, for example, please see FIG. 2C.

FIG. 2C represents that the repeating patterns 112 and the spacer patterns 114 are respectively black squares and white squares, neighboring to each other and arranged regularly, making the black squares be spaced apart by the white squares. Therefore, the repeating patterns 112 and the spacer patterns 114 form the periodic patterns RP with alternating black and white squares together.

In some embodiments, compared with FIG. 2C, the repeating patterns 112 can not only be rotated, but also be spaced apart by different spacer patterns 114, for example, please see FIG. 2D.

FIG. 2D represents that the repeating patterns 112 can be a first repeating pattern 112-1, a second repeating pattern 112-2 and a third repeating pattern 112-3 in sequence, respectively, in which the first repeating pattern 112-1, the second repeating pattern 112-2 and the third repeating pattern 112-3 are the same (that is, the shape, the figure, the size and the color are the same). The spacer patterns 114 can be a first spacer pattern 114-1 and a second spacer pattern 114-2, the figures of the first spacer pattern 114-1 and the second spacer pattern 114-2 are different. The first repeating pattern 112-1 and the second repeating pattern 112-2 are spaced apart by the first spacer pattern 114-1, and the second repeating pattern 112-2 and the third repeating pattern 112-3 are spaced apart by the second spacer pattern 114-2.

In some other embodiments, the first spacer pattern 114-1 and the second spacer pattern 114-2 can have different shapes, figures, sizes, colors or any two or more of the above. In addition, the spacer patterns 114 can have patterns that are not limited to two kinds, for example, it can have three, four or five different patterns.

In some embodiments, compared with FIG. 2E, the repeating patterns 112 are changed to be circles, and the spacer patterns 114 are irregular shapes that fill the gaps between the repeating patterns 112.

In some embodiments, please refer to FIG. 2F, compared with FIG. 2A, the repeating patterns 112 are wavy shapes, the spacer patterns 114 are white wavy shapes that fill the gaps between the repeating patterns 112.

Please go back to FIG. 1. It can be understood that since the insect prevention item 100 can prevent the flying insect FI from staying, the approach of the flying insect FI to the target item 200 can be avoided by disposing the insect prevention item 100 at the outer site of the target item 200 and realizing the efficiency of insect prevention. In some embodiments, disposing the insect prevention item 100 at the outer site of the target item 200 includes disposing the insect prevention item 100 between the target item 200 and the flying insect FI, such as covering the insect prevention item 100 over the target item 200 (such as tiling on the surface of the target item 200 or wrapping the target item 200) or surrounding the target item 200 by the insect prevention item 100.

In some embodiments, the insect prevention item 100 includes a shed, a tent, a clothing, a bag, a fruit bagging or a combination thereof. In some embodiments, the target item 200 includes creatures (such as human, domesticated animals or plants), parts of the creatures (such as human skin, domesticated animal skin, or plant fruits) or non-living subjects (such as cooked food with aroma that attracts the flying insects FI).

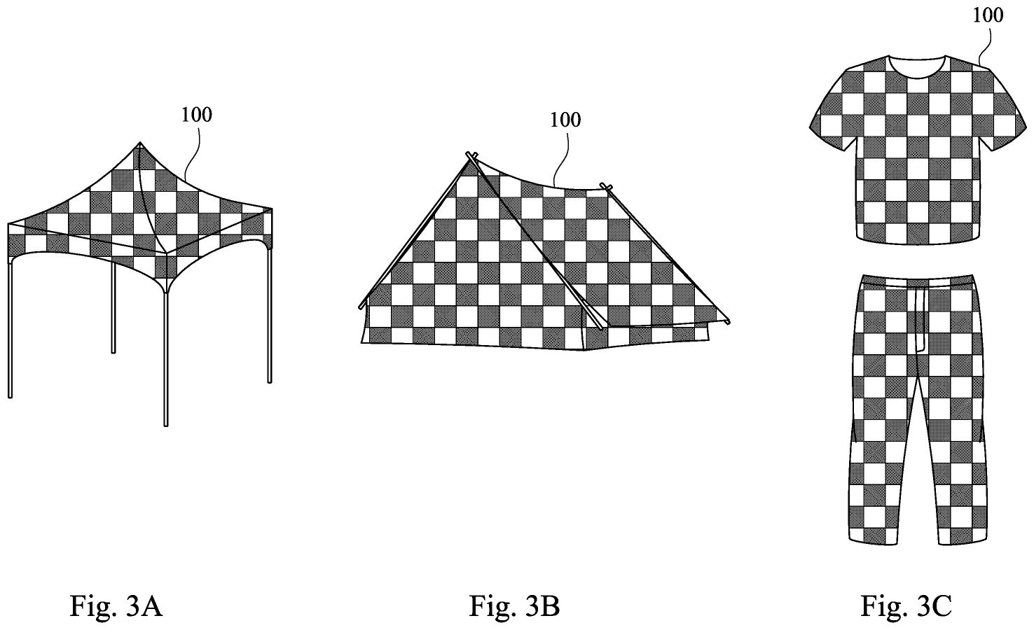

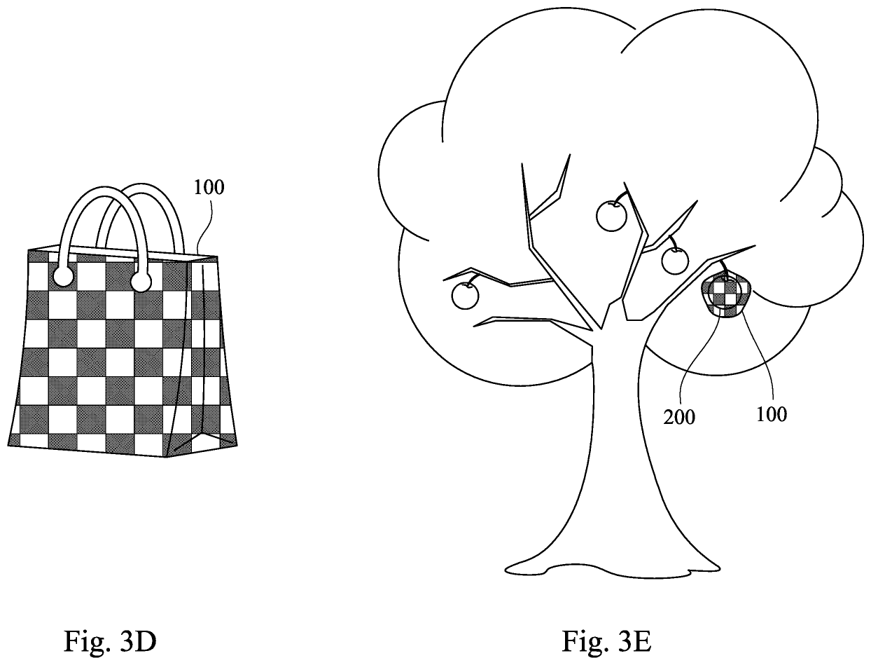

In some embodiments, please refer to FIG. 1 and FIG. 3A. The insect prevention item 100 is shed, the target item 200 is a person that moves in the internal space defined by the scaffolding of the shed (not shown in the figure). The shed (insect prevention item 100) is disposed at the outer site of the person (target item 200), isolating from the flying insect FI above and avoiding the approach of the flying insect FI.

In some embodiments, please refer to FIG. 1 and FIG. 3B, the insect prevention item 100 is a tent, and the target item 200 is a person in the tent (not shown in the figure). The tent isolates from the approach of the flying insect FI by the patterns on the surface and prevents the flying insect FI from flying into the tent (target item 200).

In some embodiments, please refer to FIG. 1 and FIG. 3C. The insect prevention item 100 is a clothing, and the target item 200 is a person wearing the clothing (not shown in the figure). The clothing wraps the skin of the person to prevent the approach from the flying insect FI

In some embodiments, please refer to FIG. 1 and FIG. 3D. The insect prevention item 100 is a bag, and the target item 200 is cooked food accommodated in the bag (not shown in the figure). The bag wraps the cooked food to prevent the flying insect FI from approaching.

In some embodiments, please refer to FIG. 1 and FIG. 3E. The insect prevention item 100 is a fruit bagging, and the target item 200 is plant fruit wrapped in the fruit bagging. The fruit bagging wraps the plant fruit for preventing the flying insect FI from approaching.

Although this disclosure has been described in detail with respect to certain embodiments, other embodiments are possible. Accordingly, the spirit and scope of the appended claims should not be limited to the embodiments described herein.

What is claimed is:

1. Use of insect prevention, comprising:
providing an insect prevention item, wherein a plurality of repeating patterns and a plurality of spacer patterns are represented on a surface of the insect prevention item, each of the plurality of repeating patterns is spaced apart by each of the plurality of spacer patterns, and a viewing angle of one of the plurality of repeating patterns and one of the plurality of spacer patterns neighboring to the one of plurality of the repeating patterns represents on a plurality of ommatidias of a flying insect is less than twice of an inter-ommatidial angle of the flying insect; and
disposing the insect prevention item on an outer site of a target item.

2. The use of claim 1, wherein the flying insect comprises bee, mosquito, moth, butterfly, fly, dragonfly or a combination thereof.

3. The use of claim 1, wherein the inter-ommatidial angle is an angle between a first central axis of a first ommatidia and a second central axis of a second ommatidia adjacent to the first ommatidia while the first central axis and the second central axis extend toward an intersection point, and the first central axis and the second central axis intersect with the insect prevention item respectively while extending in a direction of the insect prevention item.

4. The use of claim 3, wherein each of the plurality of repeating patterns comprises an upper edge of a repeating pattern, and each of the plurality of spacer patterns comprises an lower edge of a spacer pattern, the upper edge of the repeating pattern and the lower edge of the spacer pattern are opposite and isolated from each other, wherein the viewing angle is an angle between the upper edge of the repeating pattern and the lower edge of the spacer pattern while the upper edge of the repeating pattern and the lower edge of the spacer pattern extend toward the intersection point.

5. The use of claim 1, wherein when the flying insect is within 60 cm of the insect prevention item, the viewing angle of the one of the plurality of repeating patterns and the one of the plurality of spacer patterns neighboring to the one of plurality of the repeating patterns represents on the plurality of ommatidias of the flying insect is less than twice of the inter-ommatidial angle of each of the plurality of ommatidias of the flying insect.

6. The use of claim 1, wherein the insect prevention item comprises a shed, a tent, a clothing, a bag, a fruit bagging or a combination thereof.

7. The use of claim 1, wherein each of the plurality of repeating patterns comprises a striped shape, a symmetrical polygon, a circle, a wavy shape, an irregular shape or a combination thereof.

8. The use of claim 1, wherein each of the plurality of spacer patterns comprises a striped shape, a symmetrical polygon, a circle, a wavy shape, an irregular shape or a combination thereof.

9. The use of claim 1, wherein the plurality of repeating patterns are a first repeating pattern, a second repeating pattern and a third repeating pattern in sequence, wherein the first repeating pattern, the second repeating pattern and the third repeating pattern have the same shape, size and color, wherein the plurality of spacer patterns are a first spacer pattern and a second spacer pattern, the first repeating pattern is spaced apart from the second repeating pattern by the first spacer pattern, and the second repeating pattern is spaced apart from the third repeating pattern by the second spacer pattern, and the first spacer pattern and the second spacer pattern have different shapes, patterns, sizes, or colors.

10. The use of claim 1, wherein disposing the insect prevention item on the outer site of the target item comprises disposing the insect prevention item between the target item and the flying insect.

11. Use of prevention of a flying insect from staying, comprising:
providing an insect prevention item, wherein a plurality of periodic patterns side by side are represented on a surface of the insect prevention item, and a viewing angle of one of the plurality of periodic patterns represents on a plurality of ommatidias of the flying insect is less than twice of an inter-ommatidial angle of each of the plurality of ommatidias of the flying insect; and
disposing the insect prevention item on an outer site of a target item.

12. The use of claim 11, wherein the inter-ommatidial angle is an angle between a first central axis of a first ommatidia and a second central axis of a second ommatidia adjacent to the first ommatidia while the first central axis and the second central axis extend toward an intersection point, and the first central axis and the second central axis intersect with the insect prevention item respectively while extending in a direction of the insect prevention item.

13. The use of claim 12, wherein each of the plurality of periodic patterns comprises a first unit cut line and a second unit cut line opposite to the first unit cut line, wherein the viewing angle is an angle between the first unit cut line and the second unit cut line while the first unit cut line and the second unit cut line extend toward the intersection point.

14. The use of claim 11, wherein each of the plurality of periodic patterns comprises a striped shape, a symmetrical polygon, a circle, a wavy shape, an irregular shape or a combination thereof.

15. The use of claim 11, wherein each of the plurality of periodic patterns comprises a repeating pattern and a spacer pattern, wherein the repeating pattern and the spacer pattern have different shapes, figures, sizes, or colors.

16. The use of claim 15, wherein the repeating patterns of the plurality of periodic patterns neighboring to each other are spaced apart by the spacer pattern.

17. The use of claim 11, wherein when the flying insect is within 60 cm of the insect prevention item, the viewing angle of the one of the plurality of periodic patterns represents on the plurality of ommatidias of the flying insect is less than twice of the inter-ommatidial angle of each of the plurality of ommatidias of the flying insect.
